(19) United States
(12) Patent Application Publication
(10) Pub. No.: US 2025/0369657 A1
(43) Pub. Date: Dec. 4, 2025

(54) METHOD AND SYSTEMS FOR HEAT RECOVERY FROM GEOTHERMALLY-HEATED FORMATIONS BY DIRECTED FLOW

(71) Applicant: GreenFire Energy Inc., Oklahoma City, OK (US)

(72) Inventors: Greg Szutiak, Oklahoma City, OK (US); Harish Chandrasekar, Oklahoma City, OK (US); Alvaro J. Amaya, Oklahoma City, OK (US); Alan D. Eastman, Oklahoma City, OK (US); John R. Muir, Oklahoma City, OK (US)

(73) Assignee: GreenFire Energy Inc., Oklahoma City, OK (US)

(21) Appl. No.: 19/225,452

(22) Filed: Jun. 2, 2025

Related U.S. Application Data
(60) Provisional application No. 63/654,736, filed on May 31, 2024.

(51) Int. Cl. F24T 10/13; E21B 4/00; F24T 10/00; F24T 10/20

(52) U.S. Cl. CPC F24T 10/13; F24T 10/20; E21B 4/00; F24T 2010/53

(57) ABSTRACT

Processes and systems are disclosed. The process may include obtaining a plurality of wells, including an injection well and a closed-loop geothermal well, drilled into a geothermally heated formation and inserting a closed-loop geothermal system, including a working fluid configured to extract heat from the geothermally heated formation and supply it to a heat utilization facility, configured to extract heat from the working fluid, located on the surface of the earth, into the closed-loop geothermal well. The process further includes injecting a flow of geothermal fluid into the geothermally heated formation through the injection well, such that the plurality of wells is configured to direct the flow of geothermal fluid from the injection well to the vicinity of the closed-loop geothermal well.

### FIELD OF DISCLOSURE

Embodiments of the current disclosure may generally relate to the recovery of heat from subsurface geological formations via the drilling and completion of wells.

### BACKGROUND

The aim of all geothermal energy systems, regardless of their location or configuration, is to extract heat from a geothermally heated formation. Typically, this is achieved by drilling one or more wells from the surface of the earth to a geothermally heated formation in the subsurface and circulating relatively cooler fluid downward from the surface, allowing the cooler fluid to absorb heat from the geothermally heated formation, retrieving the relatively hotter fluid to the surface, and using the heat for one or more of power generation, residential, commercial, or industrial heating, and other industrial processes.

To ensure the effective and sustained extraction of heat, it is desirable that the geothermal energy systems are thermally connected to as large a portion of the geothermally heated formation as technically and economically feasible. Conventional geothermal systems deficient in thermal connectivity, such as may be provided by high permeability and an ample supply of in situ fluid, to a large portion of the geothermally heated formation may experience a decrease in the thermal output of the system as the small portion of the geothermally heated formation to which the system is connected cools due to energy extraction.

In addition, it is important that the fluid used to retrieve the heat is as free as possible from the corrosive chemicals that frequently occur naturally in geothermally heated formations and the fluids found in situ. Conventional geothermal systems that have a high level of corrosive chemical absorbed or entrained from the geothermally heated formation and carried to the surface of the earth may experience corrosion problems in the downhole and surface equipment leading to early failure or increased maintenance budgets. This is particularly problematic when the corrosive fluid undergoes a significant temperature or pressure change at the surface, such as when the corrosive fluid passes through a surface heat exchanger.

### SUMMARY

This summary is provided only to introduce a selection of concepts that are further described below in the section entitled detailed description. This summary is not intended to identify key or essential features of the claimed subject matter, nor is it intended to be used as an aid in limiting the scope of the claimed subject matter.

In general, in one aspect, embodiments relate to a process for heat recovery from a geothermally heated formation. The process may include obtaining a plurality of wells drilled from the surface of the earth into a geothermally heated formation, including at least one injection well and at least one closed-loop geothermal well, and inserting a closed-loop geothermal system into the at least one closed-loop geothermal well. The closed-loop geothermal system includes a working fluid configured to extract heat from a portion of rock and geothermal fluid in the geothermally heated formation, a heat utilization facility located on the surface of the earth, where the heat utilization facility is configured to extract heat from the working fluid, and a plurality of fluid conduits carrying working fluid flows downhole from the heat utilization facility through a first fluid conduit of the plurality of fluid conduits and the working fluid from downhole flows to the heat utilization facility through a second fluid conduit of the plurality of fluid conduits. The process further includes injecting a flow of geothermal fluid into the geothermally heated formation through at least one injection well, where the plurality of wells is configured to direct the flow of geothermal fluid from at least one injection well to a vicinity of at least one closed-loop geothermal well.

In general, in one aspect, embodiments relate to a system for heat recovery from a geothermally heated formation. The system may include a plurality of wells drilled from the surface of the earth into a geothermally heated formation, including at least one injection well and at least one closed-loop geothermal well, and a closed-loop geothermal system, inserted into each of the at least one closed-loop geothermal well. Each closed-loop geothermal system may include a working fluid, configured to extract heat from a portion of rock and geothermal fluid in the geothermally heated formation, a heat utilization facility located on the surface of the earth that is configured to extract heat from the working fluid, and a plurality of fluid conduits, carrying the working fluid flows downhole from the heat utilization facility through a first fluid conduit of the plurality of fluid conduits and the working fluid from downhole flows to the heat utilization facility through a second fluid conduit of the plurality of fluid conduits. The system may also include a fluid injection system, configured to inject a flow of geothermal fluid into the geothermally heated formation through at least one injection well, where the plurality of wells is configured to direct the flow of geothermal fluid from at least one injection well to a vicinity of at least one closed-loop geothermal well.

Other aspects and advantages of the claimed subject matter will be apparent from the following description and the appended claims.

### BRIEF DESCRIPTION OF DRAWINGS

Specific embodiments of the technology disclosed will now be described in detail with reference to the accompanying figures. Like elements in the various figures are denoted by like reference numerals for consistency. The sizes and relative positions of elements in the drawings are not necessarily drawn to scale. For example, the shapes of various elements and angles are not necessarily drawn to scale, and some of these elements may be arbitrarily enlarged and positioned to improve drawing legibility. Further, the particular shapes of the elements as drawn are not necessarily intended to convey any information regarding the actual shape of the particular elements and have been solely selected for ease of recognition in the drawing.

FIGS. 1A-1D display various prior art geothermal systems.

FIG. 2 displays a closed-loop prior art geothermal system that uses a co-axial tube-in-tube configuration to circulate fluid within a downbore heat exchange

FIG. 3 displays a drilling system in accordance with one or more embodiments.

FIG. 4 displays a hydraulic fracturing system in accordance with one or more embodiments.

FIGS. 5A-5B display multi-pad and single-pad surface configurations, respectively, of directed-flow geothermal systems in accordance with one or more embodiments.

FIG. 6A-6E display both overhead and lateral examples of well orientations in accordance with one or more embodiments.

FIG. 7 displays a flowchart in accordance with one or more embodiments.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details or with modifications to them. In other instances, well-known features have not been described in detail to avoid unnecessarily complicating the description.

Throughout the application, ordinal numbers (e.g., first, second, third, etc.) may be used as an adjective for an element (i.e., any noun in the application). The use of ordinal numbers is not to imply or create any particular ordering of the elements nor to limit any element to being only a single element unless expressly disclosed, such as using the terms “before,” “after,” “single,” and other such terminology. Rather, the use of ordinal numbers is to distinguish between the elements. By way of an example, a first element is distinct from a second element, and the first element may encompass more than one element and succeed (or precedes) the second element in an ordering of elements.

It is to be understood that the singular forms “a,” “an,” and “the” include plural referents unless the context clearly dictates otherwise. Thus, for example, reference to “a heat exchanger” includes reference to one or more of such heat exchangers.

Terms such as “approximately,” “substantially,” etc., mean that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

It is to be understood that one or more of the steps shown in the flowcharts may be omitted, repeated, and/or performed in a different order than the order shown. Accordingly, the scope disclosed herein should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims . . . .

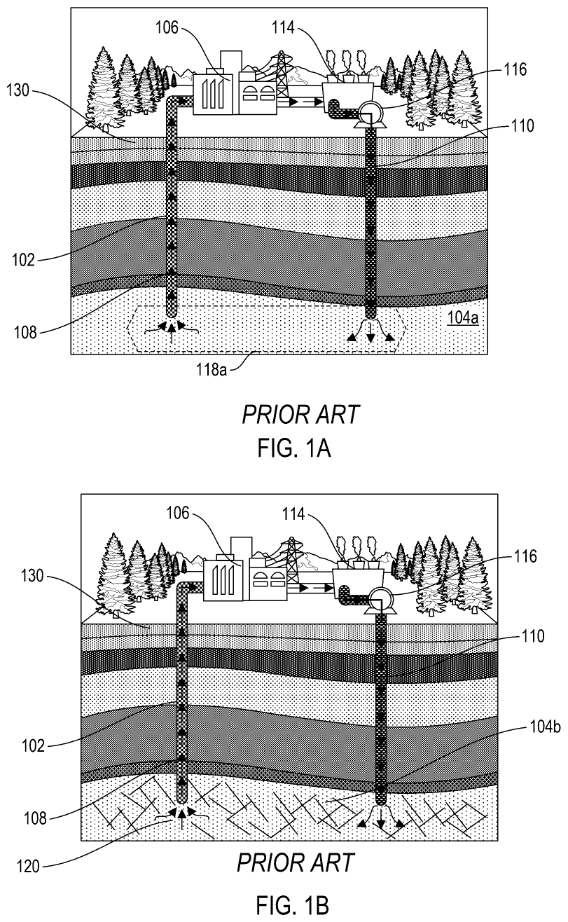

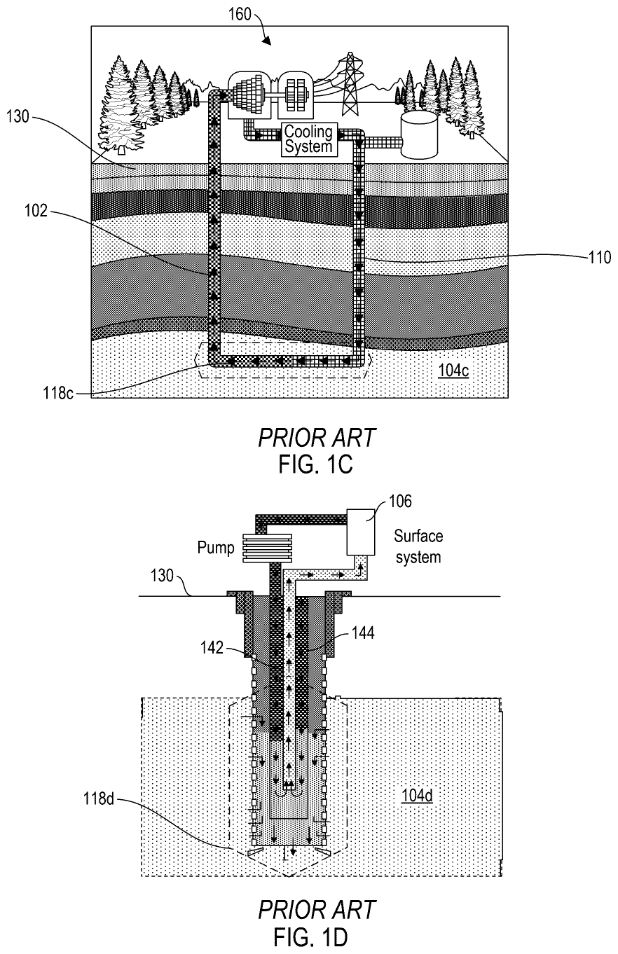

In the following description of FIGS. 1-7, any component described regarding a figure, in various embodiments disclosed herein, may be equivalent to one or more like-named components described regarding any other figure. For brevity, descriptions of these components will not be repeated regarding each figure. Thus, each and every embodiment of the components of each figure is incorporated by reference and assumed to be optionally present within every other figure having one or more like-named components. Additionally, in accordance with various embodiments disclosed herein, any description of the components of a figure is to be interpreted as an optional embodiment which may be implemented in addition to, in conjunction with, or in place of the embodiments described regarding a corresponding like-named component in any other figure.

Thermally and hydraulically connecting a closed-loop geothermal system to a large portion of a geothermal heat source is critical to the long term energy productivity of the closed-loop geothermal system. Heat may be carried by thermal conduction through the rock frame and static fluid within the pores of the geothermally heated formation driven by a thermal gradient. However, conduction is a relatively inefficient means of carrying heat through materials such as rock. When a natural fluid flow exists within the geothermally heated formation, heat may be effectively carried by the moving fluid. However, such natural subsurface fluid flow rarely occurs, particularly in formations with limited permeability that often comprise the thermally heated formations used by geothermal systems. In addition, high temperature geothermally heated fluids often carry corrosive salts and other chemicals that can negatively affect the productivity and productive lifespan of geothermal systems if the design of the geothermal systems require such geothermal fluids to be transported to the surface and cooled, for example in a heat exchanger located on the surface, prior to being reinjected into the subsurface or otherwise disposed of.

Disclosed herein are systems and methods to force and direct by controlling to a large degree the rate, volume, and direction of fluid flow through the geothermally heated formation from portions with elevated temperatures to and past wells containing closed-loop geothermal systems. Such methods and systems constitute a significant improvement over existing methods and systems ensuring high productivity and longer productive lifetimes than current systems can provide. Specifically, disclosed embodiments may provide closed-loop geothermal systems that may efficiently extract larger quantities of heat by accessing greater volumes of geothermally heated formation than existing systems, and do so without extracting and cooling at the surface large quantities of geothermal fluid that may carry harmful chemicals, salts, and gases. Other embodiments may provide for monitoring the rate of heat extraction from the geothermally-heated formation in order to sustain the production of high levels of heat over long periods of time.

FIGS. 1A-1D illustrate existing types of geothermal systems. Beginning with FIG. 1A, FIG. 1A shows an example of a conventional geothermal system (“CGS”) system consisting of two wells, an extraction well (102) and an injection well (110), drilled into permeable geothermally heated formation (104a) that may also contain naturally occurring geothermal fluids. The geothermal fluids naturally present in the formation may initially be in thermal equilibrium with, and at the same temperature as, the hot rock of the formation. These hot geothermal fluids (108) may be produced through an extraction well (102) flowing naturally, up or with artificially enhanced flow provided by pumps as prescribed by engineers ordinarily conversant with the art, the extraction well (102) to the surface of the earth (130). Hot geothermal fluids may then be used in a heat utilization facility (106), that may contain turbines and generators, to produce power.

The method of power production depends on the composition and temperature of the formation fluid, and may be chosen from among such methods as steam flash, ORC, kalian cycle, total flow expanders or other power generating systems such as thermoelectric generators, and the like, as determined by engineers familiar with the art.

In addition, the fluid may be further cooled in cooling towers (114) or other suitable cooling mechanisms, and/or used in residential, commercial, or industrial dual-use heating systems before the cooled fluid is reinjected into the geothermally heated formation (104a) through the injection well (110) using a pump (116).

As a result, a CGS may drain heat, carried by hot geothermal fluids (108) from a portion (118a) of the geothermally heated formation (104a) that may lie substantially between the injection well (110) and the extraction well (102).

CGS thus requires the simultaneous presence in the geothermally heated formation (104a) of hot rock with both adequate porosity and permeability, plus an appropriate geothermal fluid. It can be difficult to find locations where heat, permeability, and formation fluids are found together at appropriate levels. More specifically, less than 5% of potential geothermal resources have both the water and permeability needed for commercial power generation. In addition, geothermal fluids frequently carry high levels or corrosive chemicals, such as dissolved mineral salts, and/or toxic gases. When these geothermal fluids experience temperature and pressure reductions at the surface of the earth (130) they may produce high levels of corrosion and scaling in equipment, such as generators and turbines, that may increase the maintenance needs of the geothermal systems and/or shorten their functional lives. As a result, CGS is widely regarded in the art as an inadequate solution that is limited to certain geographies and cannot be implemented in a widespread fashion across the world.

FIG. 1B illustrates an Enhanced Geothermal System (“EGS”). EGS systems attempt to solve some of the problems of CGS by requiring only the presence of heated rock and large volumes of water, but not requiring significant natural porosity or permeability. In EGS, porosity and permeability are generated in the rock formation by using one or more stimulation techniques common in both the geothermal and hydrocarbon extraction industries to produce a stimulated geothermally heated formation (104b) containing porosity and permeability in the form of fractures, such as fracture (120), in the rock of the stimulated geothermally heated formation (104b). These stimulation techniques include, without limitation, hydraulic fracturing—with or without proppant—acidizing, pressurized acidizing, and pulsed energetics (i.e., a method unlike conventional hydraulic fracturing, that uses rapid, high-pressure pulses to generate micro-fractures and clean existing channels near the well, thus improving fluid flow), applied individually or in combination. If formation fluids (most commonly water) are absent in the geothermally heated formation, fluids may be selected by the geothermal system operator for injection into the formation through one or more injection wells, such as injection well (110). EGS thus takes a hot dry formation and artificially generates a man-made stimulated geothermally heated formation (104b) analogous to a naturally occurring geothermally heated formation (104a) of a CGS system.

There are several disadvantages to typical CGS and EGS operations. In particular, the operator must deal with the formation fluids produced to the surface, which may include high concentrations of corrosive substances like salt, and other dissolved minerals that can adhere to and occlude the piping arrangements to and in the surface equipment. In addition, many subsurface fluids, including those circulated through the formation during the EGS process, contain dissolved and/or non-condensable gases, notably hydrogen sulfide and carbon dioxide, which are not only corrosive but also toxic, sometimes, as in the case of hydrogen sulfide, deadly

Furthermore, EGS often requires large amounts of water available for injection as the recovery factor, i.e., the ratio of the volume of fluid recovered to the volume of fluid injected, can be very small. This implies that a significant amount of fluid injected through the injection well is never recovered through the extraction well, and additional fluid must be added at the surface in a near continuous manner (make-up fluid requirements). Thus, EGS may depend on the availability of water, inexpensively and in high volumes, to inject into the formation.

Despite these problems, EGS has gained popularity because it takes advantage of well-developed techniques to fracture geologic formations, thereby taking advantage of large portions of a geothermally heated formation from which it can extract heat. EGS also takes advantage of efficient heat changes predominantly through convection as well as heat conduction through the rock of the formation.

FIG. 1C illustrates an Advanced Geothermal System (“AGS”), specifically a U-shaped AGS. AGS avoids the problems associated with producing formation fluids by employing closed-loop systems. A working fluid is circulated within the closed loop. The working fluid is first pumped down a fluid conduit within an injection well (110), then flowing through a substantially horizontal section (122) traversing in a geothermally heated formation (104c), and back up an extraction well (108) to the surface of the earth (130). The working fluid within the closed loop never interacts directly with the rock of the geothermally heated formation, nor with the geothermal fluids therein and consequently undesirable chemicals, salts, and gases from the geothermally heated formation do not mix with the working fluid.

However, while passing through the substantially horizontal section (122) traversing in a geothermally heated formation (104c), the working fluid may be heated via thermal conduction so that the heat is still obtained from the geothermally heated formation (104c) and is carried to the surface by the working fluid in the closed loop. The ability of the closed-loop system to operate in fluid isolation from the geothermal fluid in the geothermally heated formation (104c) prevents the production of potentially contaminated geothermal fluid to the surface and also allows the use of alternative types of fluids, such as hydrocarbons or supercritical CO₂, as working fluids. Such fluids can be chosen so as to improve heat extraction or well longevity depending on well conditions. Open systems such as CGS and EGS generally cannot use these alternative fluids because of the risk of contaminating the subsurface and also because fluid loss into the formation would make such systems non-economic.

Thus, the closed-loop nature of AGS eliminates the risk of formation contamination or pollution of aquifers in the formation. As a result, AGS systems are frequently easier to permit and less exposed to litigation than CGS or EGS systems. However, AGS can require advanced capabilities for directional and horizontal drilling and, in case of U-shaped AGS difficult to achieve intersection of two wells (the “injection side” and the “extraction side”) within the geothermally heated formation.

An alternative form of a closed-loop system is illustrated in FIG. 1D. This form is frequently referred to as co-axial AGS or “pipe-in-pipe” configuration (140) and consists of an open-ended inner pipe (142) inserted within a sealed or close-ended outer pipe (144). The working fluid may be pumped down the annulus (146) between the open-ended inner pipe (142) and the close-ended outer pipe (144) and then return to the surface of the earth (130) through the interior of the open-ended inner pipe (142). Alternatively, working fluid may be pumped down the interior of the open-ended inner pipe (142) and return to the surface of the earth (130) through the annulus (146) between the open-ended inner pipe (142) and the close-ended outer pipe (144).

Unfortunately, AGS systems, both U-shaped and pipe-in-pipe, suffer from a key problem, namely the lack of surface area through which to absorb geothermal heat from the formation into the system. The surface area of a single-well AGS system is a small fraction of the surface area of a typical EGS installation. As a result, the amount of heat produced, and the amount of power generated, is reduced commensurately. A further limitation is that, unless there is natural subsurface water/brine flow, a closed-loop geothermal system depends solely on thermal conduction for heat transfer from the rock of the geothermally heated formation to the AGS. Thermal conduction through rock, in the absence of fluid, is well known in the art to be an inefficient method of transporting heat over long distances. Accordingly, the portion (118c, 118d) of the geothermally heated formation (104c, 104d) that can provide heat to the AGS is relatively limited and relatively quickly depleted (cooled). Although this limitation can be mitigated with advanced well geometries, such as multiple laterals, doing so adds significantly to cost and complexity and is of limited ability to make up for the lack of convective heat flow.

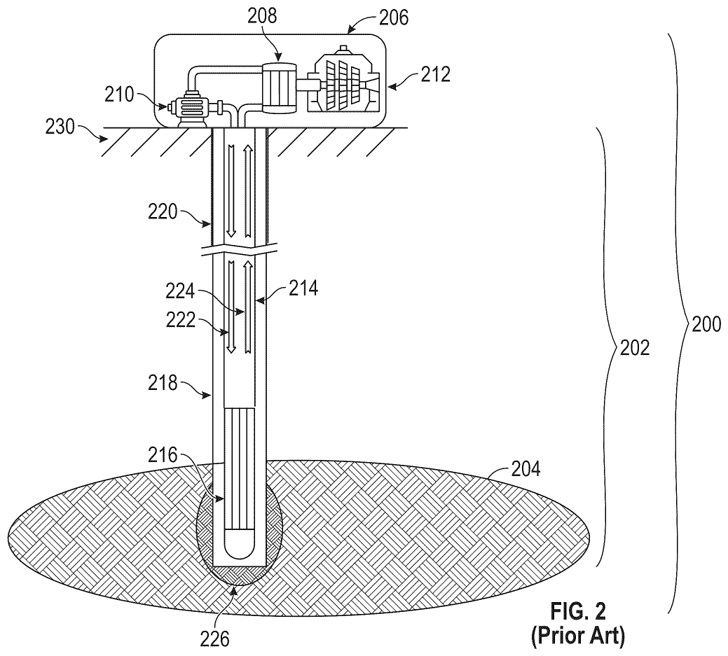

Closed-Loop: FIG. 2 depicts the elements of a closed-loop geothermal system (200) together with a method of operation in more detail. The system comprises a well (202) running from the surface of the earth (230) to a geothermally heated formation (204) in the subsurface. Typically, the heat source will be a rock formation characterized by an elevated temperature and may lie at a depth of several thousand feet below the surface of the earth (230). For example, the rock formation may be a volcanic pluton, solidified from molten lava injected by volcanic or tectonic forces between the surrounding rock formations, and exhibit low fluid permeability. The well (202) may be substantially vertical, as shown, or may be significantly deviated. The well (202) may also have horizontal portions or even have portions that become shallower with increasing distance along the well.

Note geothermally heated formations may typically have temperatures between 150 and 450 degrees Celsius (300 and 850 degrees Fahrenheit). For example, some geothermally heated formations may have a substantially constant temperature of 150 degrees Celsius (300 degrees Fahrenheit), while others may have a substantially constant temperature of 450 degrees Celsius (850 degrees Fahrenheit). However, other geothermally heated formations may have a variable temperature, for example a temperature that increases with depth from 150 degrees Celsius (300 degrees Fahrenheit) at relatively shallower depth and higher temperatures, e.g., 150 degrees Celsius (850 degrees Fahrenheit) at relatively greater depths. While vertical wells, with a relatively short length within the geothermally heated formation, may be adequate in hotter geothermally heated formations, highly deviated, or horizontal wells with relatively longer sections within the geothermally heated formation may be required to absorb the required amount of heat in relatively cooler formations.

Portions of the well may be cased and in addition may be cemented, i.e., cement may fill the annulus between the casing and the rock through which the well is drilled. Typically, casing may be a steel pipe, to form a cased hole (220). Typically, at least the shallowest portions of the well may be cased and cemented to provide mechanical stability to the well and/or to isolate near surface ground water, including drinking water aquifers from fluid originating at deeper depths and/or the drilling fluids used to create the well (202). Often the casing will be cemented into place, using an annular sheath of cement between the exterior surface of the casing and the rock wall of the well. In some cases, multiple sets (“strings”) of casing (not shown) may be present, disposed within one another and substantially sharing a common axis. Other portions of the well (202) may be left uncased to create “openhole” portions (218) of the well (202). Alternatively portions of the well (202) may be completed using “slotted-sleeve” tubing or “slotted-sleeve” casing. While casing essentially isolates the interior of the cased hole (220) from the fluids in the surrounding rock formation and provides additional thermal insulation in the form of one or more layers of steel and cement, openhole portions (218) permit fluid, including hot fluid, and heat to flow more easily into and out of the openhole portion (218). Openhole portions in the targeted thermal reservoirs may be cased and may be slotted but are always uncemented.

At, near, or above the surface of the earth (230) the well (202) may connect to a heat utilization facility (206). The heat utilization facility (206) may include, without limitation, one or more heat exchangers, such as an uphole heat exchanger (208) to extract heat energy from the hot working fluid (224), and/or one or more turbines, such as turbine (212) to generate electrical power. The uphole turbine(s) may be connected to the uphole heat exchanger(s) or connected directly to the tubulars carrying the hot working fluid (224) uphole.

In accordance with one or more embodiments, a downhole heat exchanger (216) may be deployed at, or near, the bottom of the well (202). The downhole heat exchanger (216) may function to heat the working fluid (222) supplied to it by transferring heat from hot geothermally heated formation and geothermal fluid surrounding the downhole heat exchanger (216) and producing hot working fluid (224). In some embodiments, the downhole heat exchanger may consist simply of a first fluid conduit carrying cooler working fluid from the surface fluidically connected to a second fluid conduit carrying warmer fluid to the surface. In some embodiments, the first fluid conduit and the second fluid conduit may be coaxial with the first fluid conduit inside the second fluid conduit, or vice vera. In other embodiments, the downhole heat exchanger may include a more complicated, and longer, series of conduits connecting the first conduit to the second conduit and designed to lengthen the period of time a portion of fluid spends in the lowest, warmest, portion of the closed-loop geothermal well to absorb heat.

Tubulars (pipes), such as bidirectional tubulars (214) may fluidically connect the downhole heat exchanger (216) with the heat utilization facility (206) on the surface of the earth (230), and particularly with the uphole heat exchanger (208), allowing cool working fluid (222) to flow, or to be pumped, for example by uphole pump (210), downhole, and hot working fluid (224) to flow uphole. The tubulars may be configured to allow cool working fluid (222) to flow in one direction and hot working fluid (224) to flow in the opposite direction without mixing with one another.

Cool working fluid (222) may extract heat, for example using downhole heat exchanger (216), from the geothermally heated formation (204), i.e., the hot rock formation. However, particularly in low permeability rocks the extraction of heat will cool the rock formation in a region surrounding the downhole heat exchanger (216), causing the temperature of this restricted zone (226) surrounding the downhole heat exchanger (216) to cool. Since many rocks are poor conductors of heat, and in low permeability rocks hot fluids cannot easily percolate into the restricted zone (226), the extracted heat cannot be easily replaced from more distant portions of the geothermally heated formation (204) and the efficacy of the system may decrease over time.

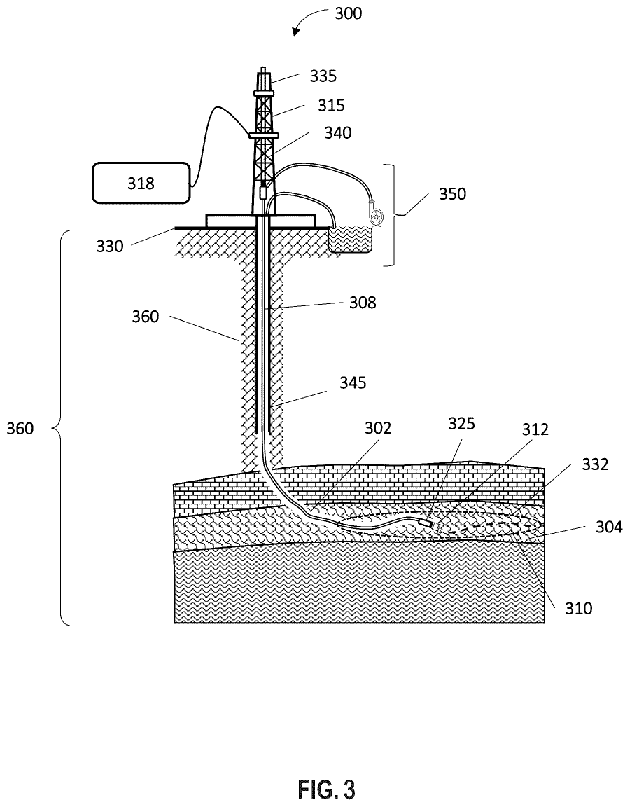

In some embodiments of the closed-loop geothermal systems disclosed herein, a pre-existing well (202) may be used. For example, a well previously drilled to provide fresh water, for geotechnical purposes, for open-loop geothermal purposes, or for hydrocarbon exploration may be used or extended for the closed-loop geothermal inventive system. In other embodiments, the well (202) may be drilled specifically for the construction of the closed-loop geothermal invention using a well drilling system, such as the well drilling system depicted in FIG. 3.

Closed-loop geothermal systems require one or more wells for deployment of downhole equipment or for injection or production of fluids. In some embodiments, the wells may be pre-existing, for example water wells or hydrocarbon wells, but often water wells are too shallow to penetrate geothermally heated formation and/or the geology conducive to hydrocarbon deposits is not suitable geology for geothermally heated formations. In these circumstances, new well designed specifically for the geothermal system must be drilled. Many similarities may exist between drilling rigs used for drilling hydrocarbon wells and those used for drilling wells for geothermal systems. In each case, the functional parameters of the drilling system, such as maximum power, torque, hoisting capacity, and weight-on-bit, may be chosen based on the planned characteristic of the well, such as depth and caliper (radius), and of the rock, such as resistance to drilling.

FIG. 3 illustrates a drilling system (300) in accordance with one or more embodiments. In some embodiments, the drilling system (300) may be configured to drill a well, such as well (302) within the subterranean region of interest (340) guided by a well drilling plan, that may include a planned well path (310). In some embodiments, the well drilling plan may be designed such that the well path (310) penetrates the location of a geothermally heated formation (306) within the subterranean region of interest (340). The planned well path (310), and the resulting well (302) may include substantially vertical portions, deviated and highly deviated portions, and horizontal portions, without departing from the scope of the invention.

Although the drilling system (300) shown in FIG. 3 is depicted as drilling a well (302) on land, the drilling system (300) may be a marine well drilling system, including a jack-up rig, floating rig, semi-submersible rig, or drillship, without departing from the scope of the invention.

As shown in FIG. 3, the drill rig may be equipped with a hoisting system, such as a derrick (315), which can raise or lower a drillstring (308) and other tools required to drill the well (302). The drillstring (308) may include one or more drill pipes connected to form conduit and a bottom hole assembly (BHA) (325) disposed at the distal end of the drillstring (308). The BHA (325) may include a drill bit (312) to cut into rock (360). The BHA (325) may further include measurement tools, such as a measurement-while-drilling (MWD) tool and logging-while-drilling (LWD) tool. MWD tools may include sensors and hardware to measure downhole drilling parameters, such as the azimuth and inclination of the drill bit (312), the weight-on-bit, and the torque. The LWD measurements may include sensors, such as resistivity, gamma ray, and neutron density sensors, to characterize the rock (360) surrounding the well (302). Both MWD and LWD measurements may be transmitted to the surface of the earth (330) using any suitable telemetry system known in the art, such as a mud-pulse or by wired-drill pipe.

The following is a description of some current industry drilling practices, but the description should not be understood to preclude using different drilling techniques that may be available now or may become available in the future. To start drilling, or “spudding in,” the well (302), the hoisting system lowers the drillstring (308) suspended from the derrick (315) of the drill rig towards the planned surface location of the well (302). An engine, such as a diesel engine, may be used to supply power to a top drive (335) to rotate the drillstring (308) via a drive shaft (370). The weight of the drillstring (308) combined with the rotational motion enables the drill bit (312) to bore the well (302).

The near-surface rock of the subterranean region of interest (340) is typically made up of loose or soft sediment or rock, so large diameter casing (345) (e.g., “base pipe” or “conductor casing”) is often put in place while drilling to stabilize and isolate the near-surface well. At the top of the base pipe is the wellhead (not shown), which serves to provide pressure control through a series of spools, valves, or adapters. Once near-surface drilling has begun, water or drill fluid may be used to force the base pipe into place using a pumping system until the wellhead is situated just above the surface of the earth (330).

Drilling may continue without any casing (345) once deeper or more compact rock (360) is reached. While drilling, a drilling mud system (350) may pump drilling mud from a mud tank on the surface of the earth (330) through the drill pipe. Drilling mud serves various purposes, including pressure equalization, removal of rock cuttings, and drill bit cooling and lubrication.

At planned depth intervals, drilling may be paused and the drillstring (308) withdrawn from the well (302). Sections of casing (345) may be connected, inserted, and cemented into the well (302). Casing string may be cemented in place by pumping cement and mud, separated by a “cementing plug,” from the surface of the earth (330) through the drill pipe. The cementing plug and drilling mud force the cement through the drill pipe and into the annular space between the casing (345) and the wall of the well (302). Once the cement cures, drilling may be recommenced. The drilling process is often performed in several stages. Therefore, the drilling and casing cycle may be repeated more than once, depending on the depth of the well (302) and the pressure on the walls of the well (302) from surrounding rock (360).

Due to the high pressures experienced by deep wells, a blowout preventer (BOP) may be installed at the wellhead to protect the rig and environment from unplanned oil or gas releases. As the well (302) becomes deeper, both successively smaller drill bits (312) and casing (345) may be used. Drilling deviated or horizontal wells may require specialized drill bits (312) or drill assemblies.

The drilling system (300) may be disposed at and communicate with other systems in the well environment, such as the well planning system (318). The drilling system (300) may control at least a portion of a drilling operation by providing controls to various components of the drilling operation. In one or more embodiments, the drilling system (300) may receive data from one or more sensors arranged to measure controllable parameters of the drilling operation. As a non-limiting example, sensors may be arranged to measure weight-on-bit, drill rotational speed (RPM), flow rate of the mud pumps (GPM), and rate of penetration of the drilling operation (ROP). Each sensor may be positioned or configured to measure a desired physical stimulus. Drilling may be considered complete when a drilling target (332) within the geothermally heated formation (304) is reached.

The direction of a well may be controlled by both active and passive directional drilling (or steering). In passive directional drilling the well trajectory is determined by the flexing or buckling of the drilling (308) in response to the application of greater or lesser weight-on-bit and the design of the BHA (325). A conventional BHA equipped with multi-stabilizers may be used to control the hole deviation angle based on the lever principle or pendulum effect. However, the resulting well path is also influenced by the natural features of strength or weakness of the rock formation and so the precision with which the well trajectory can be controlled may be limited.

Active directional drilling may be performed using a variety of specialized BHA and drill bits known in the art. For example, BHA components known as “bent-subs” may hold the drill bit at a fixed orientation of a few degrees of deviation (typically, 1 or 2 degrees of angle) to the axis of the BHA. When the drillstring (308) is rotated the drill bit bores a portion of the well in a direction parallel to the axis of the BHA. In contrast, when the drillstring (308) is unrotated but the drill bit rotated by a motor (e.g., a mud-motor or an electrical motor) then the well is extended in the direction of orientation and the rate of deviation of the drillbit. Alternatively, wells may be deviated using rotatory steerable devices (RSD) that use continuously adjusted pressure pads on the BHA to push or point the drill bit, and hence the resulting well, in the desired direction. Since RSDs work with the drillstring continuously rotating they are often preferred over bent-subs because of their superior drillstring drag-reduction and hole cleaning characteristics.

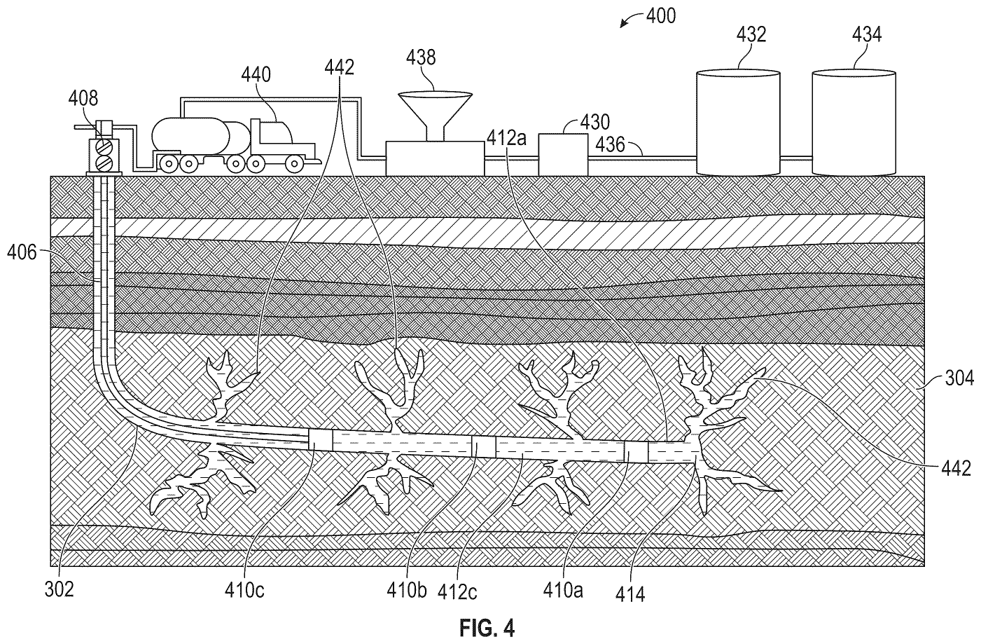

FIG. 4 illustrates a stimulation system, specifically a hydraulic fracturing system (400) performing a hydraulic fracturing operation in accordance with one or more embodiments. The hydraulic fracturing system (400) and hydraulic fracturing operation are for illustration purposes only. The scope of the disclosure is intended to encompass any type of hydraulic fracturing system (400) and hydraulic fracturing operation. However, in some embodiments the hydraulic fracturing system used in embodiments may often be a small scale, “slimmed-down”, or minimal system, when compared to a conventional hydrocarbon-oriented fracturing system, as will be described below. This has the advantage of reducing unnecessary cost, time, and environmental impact.

In some embodiments, the hydraulic fracturing operation is performed by separating the well (302) into multiple well lengths separated by packers (410a-c) that hydraulically isolate the intervening lengths, sometimes termed “stages e.g., stages (412a-c). Each stage may be connected by tubing (406) to a set of valves attached to the wellhead at the surface, sometimes termed a “frac tree” (408). In some embodiments, a first packer (410a) may be installed near the toe of the well (414) to form a first stage (412a) that may be fractured. Then a second packer (410b) may be installed to form a second stage (412b) between the first packer (410a) and the second packer (410b) that may be fractured. Similarly, additional packers, e.g., packer (410c), may be installed sequentially one at a time to form additional stages, e.g., stage (412c) that may be fractured prior to the installation of the next pack in the sequential series. In other embodiments, a plurality of packers (410a-c) may be installed first with each stage connected to the tubing (406) from the frac tree (408) before isolating and fracturing each stage (412a-c) sequentially using valves (not shown) within the tubing (406). Typically, the tubing (406) and all the packers (410a-c) are removed from the well after the hydraulic fracturing is completed. In general, a single well (302) may have anywhere from one to more than forty stages, however for the embodiments described herein typically only a small number of stages may be contemplated.

In an openhole portion of the well hydraulic fracturing may, for each stage, include a pumping operation where high pressure fluid is pumped into the stage until the surrounding rock fractures. In cased-hole portions, where the casing is cemented, i.e., the annulus between the outer surface of the casing and the rock wall of the wellbore, is wholly or partially filled with cement, each stage may also include a perforation operation where holes are formed through the casing, often with the aid of explosive charges. In other cases, particularly high-temperature cases, for example where the temperature may exceed 300 degrees Celsius (450 degree Fahrenheit), slotted-liners or sliding sleeves may be inserted into the well at the desired location within the geothermally heated formation, to provide permanent, or controllable, hydraulic connection to the geothermally heated formation, thus permitting hydraulic stimulation.

FIG. 4 shows a frac tree (408) similar to a production tree but is specifically installed for the hydraulic fracturing operation, with larger bores, higher-pressure ratings and abrasive resistant materials. FIG. 4 further shows chemical storage containers (430), water storage containers (432), and proppant storage containers (434) that are constituents of the hydraulic fracturing system (400). In some embodiments disclosed herein, proppants and hence proppant storage containers (434) are not necessary, and the proppant storage containers (434) may be omitted. Frac lines (436) transport the chemicals, proppant, and water from the storage containers (430), (432), (434) into a frac blender (438).

The frac blender (438) blends the water, chemicals, and proppant to become the frac fluid (428) that is then channeled to one or more frac pumps mounted on pump trucks (440), to be pumped through the frac tree 408 into the well. The frac fluid is transported from the frac manifold to the frac tree (408) using frac lines (436).

Initially, high fluid pressure creates the hydraulic fractures, i.e., hydraulic fracture (442), later proppant, such as sand, may be pumped into the hydraulic fractures where the proppant props open the fractures (442) once the fluid pressure is released. Different chemicals may be used to lower friction pressure, prevent corrosion, etc. The pumping operation may be designed to last a certain length of time to ensure the fractures (442) have sufficiently propagated. Further, the frac fluid may have different make ups throughout the pumping operation to optimize the pumping operation without departing from the scope of the disclosure herein.

These stimulation techniques include, without limitation, hydraulic fracturing—with or without proppant—acidizing, pressurized acidizing, and pulsed energetics (i.e., a method unlike conventional hydraulic fracturing, that uses rapid, high-pressure pulses to generate micro-fractures and clean existing channels near the well, thus improving fluid flow), applied individually or in combination.

In some embodiments, acidizing, including pressurized may be performed as well as, or instead of, hydraulic fracturing, particularly when the rock formation surrounding the wells are alkaline in nature, such as carbonate and dolomite rocks. In these circumstances an acidic fluid may be pumped, sometimes under high pressure, into the naturally existing fractures, the pores of the rock (where some background permeability exists) or into the hydraulic fractures to etch the rock surfaces to increase their porosity and permeability. In other embodiments, pulsed energetic stimulation may be used to stimulate the geothermally heated formation. Pulse energetics, unlike conventional hydraulic fracturing, use rapid, high-pressure pulses to generate micro-fractures and clean existing channels near the well, thus improving fluid flow. The stimulation methods have many similarities with the analogous methods used in stimulation in the hydrocarbon exploration and production industry. However, as applied to the disclosed embodiments, the intensity and spatial extent of the required stimulated region is significantly smaller than those required in the hydrocarbon exploration and production industry. This reduction in scale corresponds to a reduction in the number, size, and power rating of the stimulation equipment and materials, translating in turn to a lower cost. Indeed, as applied to the disclosed embodiments, the intensity and spatial extent of the required stimulated region is significantly smaller than those required for conventional EGS systems, because the resulting permeability of the stimulated volume does not need to be as high as for conventional EGS systems. For example, for disclosed embodiments the required permeability may only need to be 50-500 milli-Darcy.

Collectively, these stimulation techniques including, without limitation, hydraulic fracturing (with or without proppant) acidizing, pressurized acidizing, and pulsed energetics, may be termed “hydraulic stimulation” and when applied individually or in combination may produce a hydraulically stimulated formation. When the hydraulic stimulation procedure, is completed, a closed-loop geothermal system (200) may be installed in the hydraulically stimulated formation, or the well may be prepared for fluid injection into, or extraction from, the hydraulically stimulated formation.

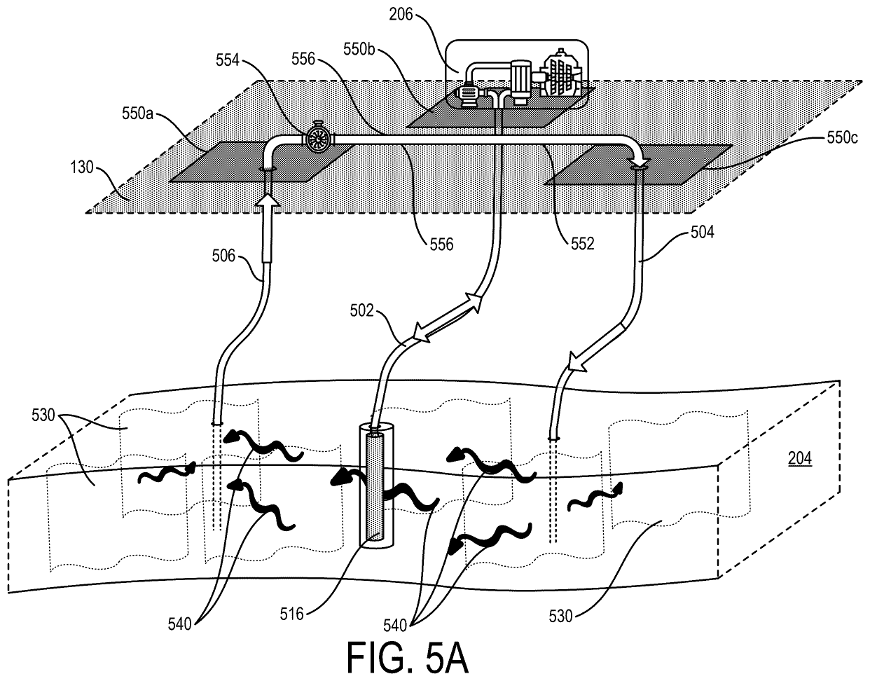

Directed flow: FIG. 5A shows a directed-flow closed-loop geothermal system (“DFCLGS”) in accordance with one or more embodiment. The DFCLGS may have three or more wells, including at least one closed-loop geothermal well (502), an injection well (504), and an extraction well (506). Note, in some embodiments the DFCLGS may include only one or more injection wells (504) and at least one closed-loop geothermal well (502), but no extraction wells, while in other embodiments the DFCLGS may include only one or more extraction wells (506) and at least one closed-loop geothermal well (502), but no injection wells. These minimalistic embodiments are discussed in detail below.

However, irrespective of the number of injection and extraction wells, the wells (504, 506) may be configured to generate a directed flow of fluid (540) from an extended portion of the geothermally heated formation (204), where the extended portion extends beyond the immediate vicinity of the closed-loop geothermal well (502), and past the closed-loop geothermal well (502). In flowing through the extended portion of the geothermally heated formation (204) the flow of fluid (540) is heated by the hot rock of the geothermally heated formation and carries the heat to the closed-loop geothermal well (502). Thus, a steady flow of heat is conveyed by the flow of fluid (540) to the vicinity of the closed-loop geothermal well (502) and the downhole heat exchanger (516) disposed within the closed-loop geothermal well (502). As a consequence, the rate of near-well cooling is substantially reduced, and the rate of decrease in temperature at the downhole heat exchanger is substantially reduced, despite heat being extracted by the closed-loop geothermal well (502).

In some embodiments, one or more injection wells (504) may be configured to inject a fluid, such as water or naturally occurring geothermal fluid, into the geothermally heated formation causing an increase in fluid pressure in the geothermally heated formation (204) in the vicinity of the injection well (504). Driven by the pressure gradient generated by the fluid injection at the injection well (504) a flow of fluid (540) may occur towards the closed-loop geothermal well (502) and the downhole heat exchanger (516) disposed therein. In other embodiments, one or more extraction wells (506) may be configured to extract a fluid, such as water or naturally occurring geothermal fluid, from the geothermally heated formation and transporting it to the surface of the earth (130) causing a decrease in fluid pressure in the geothermally heated formation (204) in the vicinity of the extraction well (506). Driven by the pressure gradient generated by fluid extraction at the extraction well (506) a flow of fluid (540) may occur towards the closed-loop geothermal well (502) and the downhole heat exchanger (516) disposed therein. In effect, the extraction of fluid may suck the heated fluid past the closed-loop geothermal well (502). In still further embodiments, one or more injection wells, such as injection well (504) and one or more extraction wells, such as extraction well (506), may be used to force the flow of water from the injection wells to the extraction well while flowing past the closed-loop geothermal well (502).

Some embodiments may include methods for optimizing heat extraction using single or dual completion . . . . For example, embodiments may include controlling flow through two or more separate zones within a well into two or more essentially fluidically isolated sections of the geothermally heated formation. In such embodiments each section of the geothermally heated formation may be independently managed for efficient heat transfer to the at least one closed-loop geothermal wells. In some embodiments, addressing more than one essentially fluidically isolated sections Y pumps” . . . what are Y-pumps'? may be used to provide injection into, or extraction from, the sections independently. In other embodiments, electric submersible pumps (“ESP”) may be used to independently control and enhance the flow rate in different zones of the well and different sections of the geothermally heated formation.

Surface pump controlling the flow of geothermal fluid may consider gravitational potential energy of the geometry of well design and in some embodiments, thermosiphon driven pumping may enable effective management of flow control and the heat extraction process to ensure, thus governing heat flow and extraction with the flow in each zone being adjusted based on the specific thermal demands of the surrounding environment. Such heat flow and extraction may be guided by incorporating real-time monitoring and adjustment of flow rates to maintain preferred levels of heat transfer in each zone.

A variety of pumps may be used for both geothermal fluid injection and extraction including, without limitation, ESP, screw pumps, rod pump, and/or line shaft pumps.

In some embodiments, the results of stimulation, such as hydraulic fractures (530) may facilitate the flow of fluid (540) and guide the flow through the vicinity of the closed-loop geothermal well (502). For example, fluid typically flows along hydraulic fractures (530), i.e., in the plane defined by the hydraulic fractures (530) more easily than perpendicular to the hydraulic fractures (530). It is well known in the art, that the orientation adopted by hydraulic fractures may be influenced or controlled at least in part by the stress field in the subsurface. Accordingly, the location selected for the drilling of the one or more injection wells (504) and the one or more extraction wells (506) may be selected based at least in part on the location of the closed-loop geothermal well (502) and the stress field in the subsurface.

In some embodiments, fluid extracted through the one or more extraction wells (506) may have an elevated temperature (compared to ambient surface temperatures). In such a situation it may be desirable to pump the extracted fluid, using a pump, such as pump (554), through a fluid conduit (pipe) (556) to the injection well (504) where it may be reinjected through the injection well (504) into the geothermally heated formation, rather than dispose of the warm fluid at the surface and inject cooler, ambient surface temperature water into the injection well. Such recirculation may have at least two advantages over an alternative of disposing of the extracted fluid at the surface and supplying new fluid from a separate surface source. These advantages may include mitigating the need to discharge and dispose of geothermal fluids from the geothermally heated formation that may contain naturally occurring pollutant chemicals and hazardous gases at the surface and ensuring that the injected fluid is at a higher temperature when injected than would be the case if it was sourced from lower temperature surface ponds, tanks, or reservoirs.

In some embodiments, recirculated fluid may be pre-treated prior to reinjection to reduce or remove entrained or dissolved substances that may risk a reduction of permeability in the geothermally heated formation. Such substances may include, without limitation, “fines”, i.e., silt or mud particles, and or dissolved salts that, if not removed, may precipitate and block permeable pathways with the geothermally heated formation. The process of removing the entrained or dissolved substances may involve mechanical filtering of the geothermal fluid and/or chemical methods including ion exchange, distillation, and reverse osmosis.

In some embodiments, such as that illustrated in FIG. 5A, each of the wells, including the closed-loop geothermal well (502), the injection well (504), and the extraction well (506), may be drilled from a separate drill-pad (550a-c). Note, a drill-pad may constitute an area of land prepared with a hardened surface, for example rock and gravel, concrete, or similar material, that facilitates the use of heavy equipment and ultimately the installation of injection or extraction pumps and heat utilization facilities (206). Each drill-pad may require the preparation of a road prior to use to allow the transport of drilling equipment and construction to the drill-pad. However, in other embodiments, some or all of the wells, including the closed-loop geothermal well (502), the injection well (504), and the extraction well (506), may be drilled from a single drill-pad (550d) as indicated in FIG. 5B. Although, drilling from a single drill-pad (550d) may require deviated and extended reach wells to be drilled to reach their desired locations with the geothermally heated formation (204), such deviated and extended reach wells are well with the capabilities of current technology and may provide a significant reduction in the costs of surface construction.

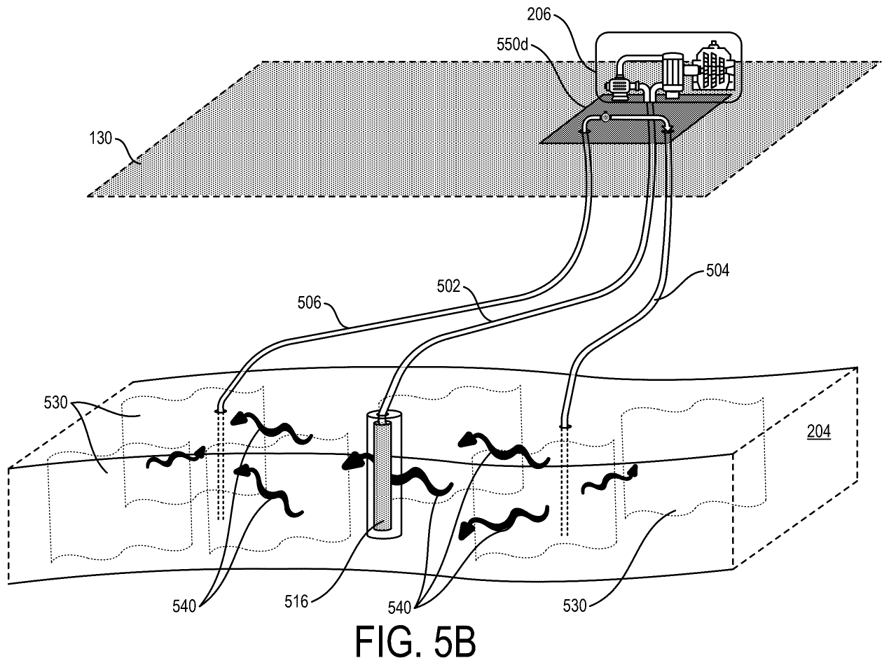

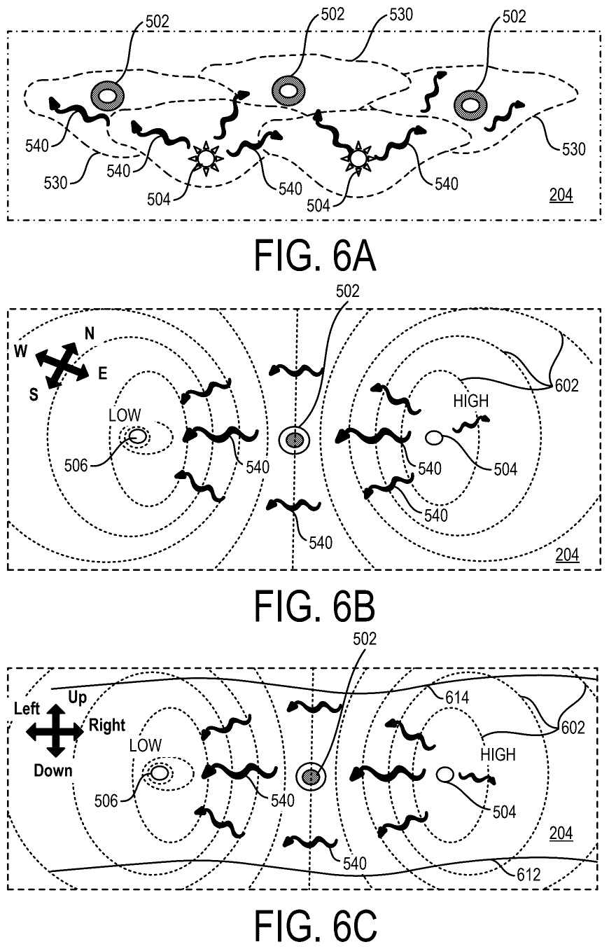

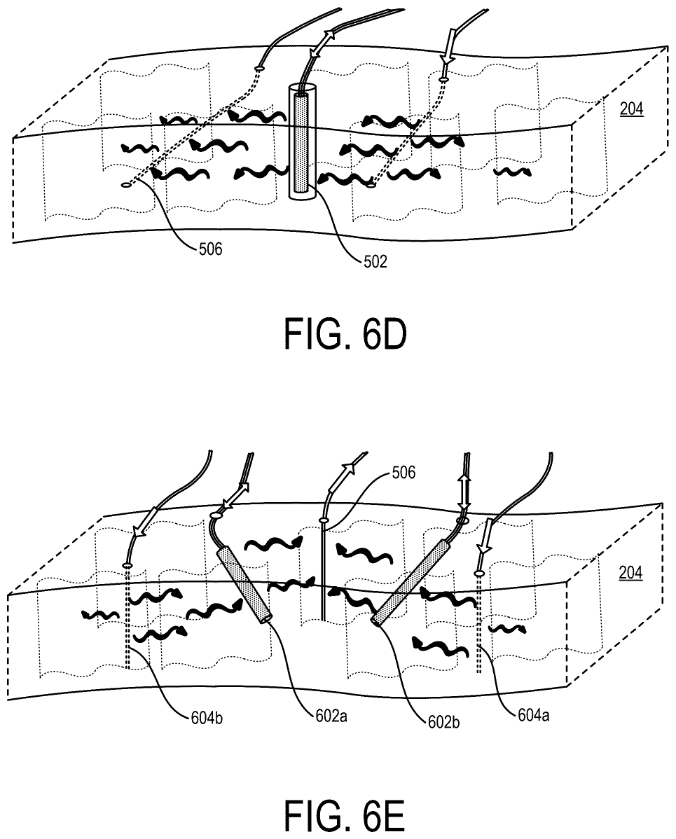

The disclosed embodiments include wells having a variety of trajectories, some of which are illustrated in FIGS. 6A-6F. For example, FIG. 6A illustrates an embodiment with five horizontal wells, including two injection wells (504) and three closed-loop geothermal system wells (502) and depicts the flow of fluid (540) whose direction of flow may be influenced by fractures (530), including hydraulic fractures.

Embodiments using two or more injection wells, as depicted in FIG. 6A, may be configured to direct fluid towards, or preferentially towards one or more of the closed-loop geothermal wells. For example, the injection rate of geothermal fluid at each of the injection wells may be varied to “steer” or direct the flow of geothermal fluid in the desired direction, i.e., towards one or more of the closed-loop geothermal wells. Similarly, the extract rate at extraction wells may be varied, for example by choking the flow from the extraction well and/or by controlling the extraction pump connected to the extraction well to direct the geothermal fluid to and through the vicinity of one or more of the closed-loop geothermal wells.

In some embodiments, directing the flow of geothermal fluids may involve the use of permeability models of the geothermally heated formation to predict the response of the subterranean flow to changes in the injection rate at each of the injections well, individually or in combination. In other embodiments, heat flow measurements may be made, using heat flow sensors, of heat extracted by the closed-loop geothermal system. Heat flow sensors may include fluid flow rate sensors, configured to measure the flow rate of the working fluid, and temperature sensors configured to measure the temperature of the working fluid both when it returns uphole, and/or the difference in the temperature of the working fluid flow pumped downhole and returned uphole. Measurements of flow rate and temperature may be combined, with or without the use of a specific heat capacity for the working fluid. Measured heat flow rates and predicted heat flow rates may be used individually or in combination to update injection and/or extraction flow rates to direct the subsurface flow of geothermal fluids preferentially to the vicinity of the closed-loop geothermal well. Sensors configured to monitor the flow rate of geothermal fluids in the injection well(s) and extraction well(s) and sensors configured to monitor heat flow and/or temperature of the working fluid in the closed-loop geothermal system may form a feedback loop to manually or automatically update geothermal fluid flow rates to vary (i.e., increase or decrease) the rate of heat recovery using the closed-loop geothermal system.

FIG. 6B illustrated an embodiment involving a vertical injection well (504), a vertical closed-loop geothermal well (502) and a vertical extraction well (506). FIG. 6B further shows idealized contours of fluid pressure (602) within the pores and fractures of the geothermally heated formation (204). The portion of the geothermally heated formation in the vicinity of the injection well (504) may exhibit a higher pressure than other regions as a result of the injection of fluid, while the portion in the vicinity of the extraction well (506) may exhibit lower pressure than other regions and a resulting fluid may flow from the vicinity of the injection well (504) to the vicinity of the extraction well (506) passing the closed-loop geothermal well (502) enroute. In its transit from the injection well (504) to the closed-loop geothermal well (502), the flowing fluid (540) may acquire heat from the geothermally heated formation (204), while in the vicinity of the closed-loop geothermal well (502) the fluid may transfer the acquired heat to the closed-loop geothermal system (200), facilitated by the downhole heat exchanger (216), before flowing on towards the extraction well (506) guided by the gradient of the fluid pressure field. Since heat is typically much more efficiently carried by percolating fluid than by thermal conduction through rock, this arrangement of fluid flow may carry heat from a much larger portion of the geothermally heated formation (204) to the closed-loop geothermal well (502) than is possible via thermal conduction alone.

FIG. 6B shows a typical arrangement of the relative positioning of the closed-loop geothermal well (502), the injection well (504), and the extraction well (506), with the distance between the closed-loop geothermal well (502) and the injection well (504) being four or five times greater than the distance between the closed-loop geothermal well (502) and the extraction well (506). This disparity of distances allows a greater heat to be absorbed by the directed geothermal fluid during its flow from the injection well (504) to the vicinity of the closed-loop geothermal well (540) than would be the case if the location of the closed-loop geothermal well (502) were closer to the injection well (504).

FIG. 6C illustrates embodiments that share elements of the examples illustrated in FIGS. 6A and 6B. For example, as with FIG. 6A, all the wells (502, 504, 506) in FIG. 6C are horizontal, and as with FIG. 6B, FIG. 6C shows an injection well (504) and extract well (506), and a closed-loop geothermal system well (502). In addition, FIG. 6C illustrates that the geothermally heated formation may have both an upper boundary (614) and a lower boundary (612).

FIGS. 6A-6C illustrates embodiments where all the wells of the embodiment are coplanar, specifically they are all either vertical or all horizontal. However, in some embodiments, this may not be the case. For example, as illustrated in FIG. 6D while the closed-loop geothermal well (502), may be vertical, the injection well (504), and the extraction well (506) may be horizontal. Conversely, in FIG. 6E the two injection wells (604a-b) and the extraction well (506) as shown as being vertical, the two closed-loop geothermal wells (602a-b) as shown as horizontal.

The orientations and numbers of each type of well, i.e., injection well, extraction well, and closed-loop geothermal system well, shown in FIGS. 6A-6E, are provided for illustration purposes only and do not exhaust possible options. For example, wells may be highly deviated from the vertical but not horizontal, and the number of injection wells may exceed the two shown in FIGS. 6A and 6E, similarly the number of closed-loop geothermal system wells may exceed the two shown in FIG. 6E. Thus, the number and orientation of wells of each type depicted should not be regarded as limiting the scope of the disclosed invention.

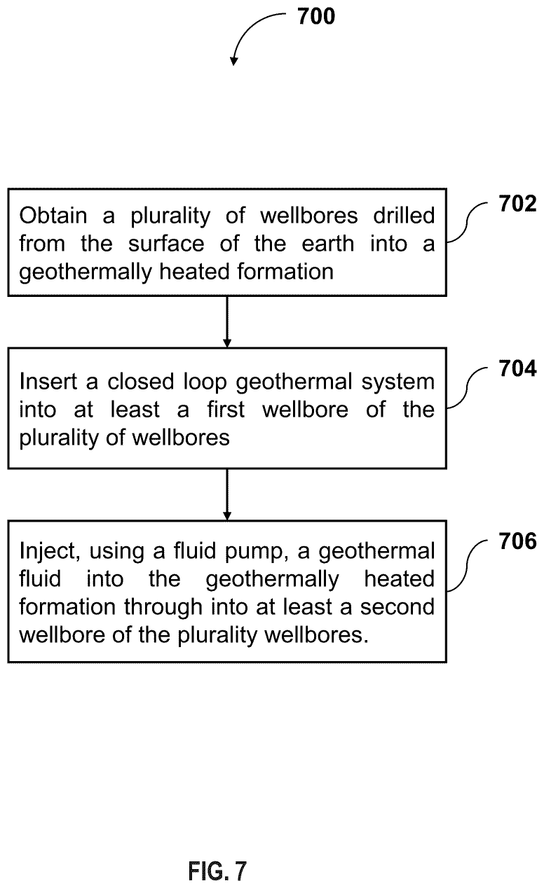

FIG. 7 shows a flowchart (700) in accordance with one or more embodiments. The flowchart commences with Step (702) in which a plurality of wells drilled from the surface of the earth into a geothermally heated formation may be obtained. The geothermally heated formation may be stimulated, for example using hydraulic fracturing and/or acidizing to produce a stimulated geothermally heated formation with the effect of increasing the porosity and, particularly, permeability of the formation. The plurality of wells may include at least one injection well and at least one closed-loop geothermal well. Further the plurality of wells may include at least one extraction well.

The plurality of wells may include at least some pre-existing wells, previously drilled for another purpose, or each of the wells may be drilled, using a drilling system, for the purpose of forming the disclosed geothermal system. The orientations of each well in the plurality of wells may be vertical, highly deviated, and/or horizontal orientations without constraint by the orientation of other wells within the plurality.

In Step (704) a closed-loop geothermal system may be inserted into at least one closed-loop geothermal well. In some embodiments, the closed-loop geothermal system may include a working fluid, a downhole heat exchanger, an uphole heat exchanger, a plurality of fluid conduits configured to conduct the working fluid flow directly, or indirectly from the uphole heat exchanger to the downhole heat exchanger through a first fluid conduit of the plurality of fluid conduits and the working fluid from the downhole heat exchanger to the uphole heat exchanger through a second fluid conduit of the plurality of fluid conduit. In other embodiments, one or more of these elements, such as the uphole heat exchanger and/or the downhole heat exchanger may be omitted. The downhole heat exchanger may be configured to extract heat from a portion of rock and fluid in the geothermally heated formation and supply it to the working fluid, and the uphole heat exchanger may be configured to extract heat from the working fluid and supply it to heat utilization facility.

In Step (706) a flow of geothermal fluid may be injected, for example using a fluid pump, into the geothermally heated formation through the at least one injection well. The plurality of wells may be configured to facilitate the flow of the geothermal fluid from the second well to a vicinity of the first well. The flow of geothermal fluid may receive heat from the geothermally heated formation and transport the heat to the first well

Further, geothermal fluid may be extracted from the geothermally heated formation through at least one extraction well. The injection and extraction wells may direct the flow of geothermal fluid from the injection well to the extraction well through the vicinity of the closed-loop geothermal well. In some embodiments the closed-loop geothermal well lies between the injection well and the extraction well, so the distance between the closed-loop geothermal well and the injection well is greater than the distance between the closed-loop geothermal well and the extraction well. Typically, the distance from the injection well to the closed-loop geothermal well may be two to five times greater than the distance between the extraction well and the closed-loop geothermal well.

Injecting the heat transfer fluid into the geothermally heated formation may also include flowing, through the extraction well, the geothermal fluid extracted from the geothermally heated formation to the surface of the earth, pumping the geothermal fluid into the injection well at the surface of the earth; and flowing, through the injection well, the geothermal fluid from the surface of the earth to the geothermally heated formation. This procedure may have at least the following advantages. Firstly, recirculating the geothermal fluid from the extraction well into the injection well eliminates, or at least greatly reduces, the need to discharge and dispose of the potentially polluted fluid at the surface. Secondly, recirculating the geothermal fluid eliminates, or at least greatly reduces, the need to obtain fresh fluid to be injected into the geothermally heated formation from a surface or subsurface aquifer source. Thirdly, the recirculated fluid may have absorbed a significant quantity of heat from the geothermally heated formation after the recirculated fluid is flowed past the closed-loop geothermal well and before it is extracted at the extraction well. This absorbed heat may be effectively used by the closed-loop geothermal system by reinjecting it through the injection well. Prior to injection, the geothermal fluid may be treated to remove materials and/or substances, such as silt and dissolved salts, that may potentially reduce the permeability of the geothermally heated formation if such materials and substances were injected into the geothermally heated formation.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed is:

1. A process for heat recovery from a geothermally heated formation, comprising:
obtaining a plurality of wells drilled from the surface of the earth into a geothermally heated formation, wherein the plurality of wells comprises at least one injection well and at least one closed-loop geothermal well;
inserting a closed-loop geothermal system into the at least one closed-loop geothermal well, wherein the closed-loop geothermal system comprises:
a working fluid, configured to extract heat from a portion of rock and geothermal fluid in the geothermally heated formation,
a heat utilization facility located on the surface of the earth, wherein the heat utilization facility is configured to extract heat from the working fluid, and
a plurality of fluid conduits, wherein the working fluid flows downhole from the heat utilization facility through a first fluid conduit of the plurality of fluid conduits and the working fluid from downhole flows to the heat utilization facility through a second fluid conduit of the plurality of fluid conduits; and
injecting a flow of geothermal fluid into the geothermally heated formation through the at least one injection well,
wherein the plurality of wells is configured to direct the flow of geothermal fluid from the at least one injection well to a vicinity of the at least one closed-loop geothermal well.

2. The process of claim 1, further comprises extracting at least a portion of the flow of geothermal fluid from the geothermally heated formation through at least one extraction well of the plurality of wells, wherein the at least one injection well and the at least one extraction well are configured to direct a flow of geothermal fluid from the at least one injection well to the at least one extraction well through the vicinity of the at least one closed-loop geothermal well.

3. The process of claim 2, wherein:
a first distance between at least one closed-loop geothermal well and the at least one injection well is greater than a second distance between the at least one closed-loop geothermal well and the at least one extraction well; and
a third distance between the at least one extraction well and the at least one injection well is greater than the first distance.

4. The process of claim 2, further comprising:
determining, using a heat flow sensor disposed in the closed-loop geothermal system, a measured flow of heat from the closed-loop geothermal system; and
adjusting at least one of an injection rate of geothermal fluid through an injection well and an extraction rate of geothermal fluid through an extraction well to increase the measured heat flow rate.

5. The process of claim 1, wherein:
the injection of geothermal fluid through at least one injection well and the extraction of geothermal fluid through the at least one extraction well is configured to preferentially direct the flow of geothermal fluid towards the at least one closed-loop geothermal well; and
the flow of geothermal fluid transports heat absorbed from the geothermally heated formation between the at least one injection well and the at least one closed-loop geothermal well.

6. The process of claim 2, wherein injecting the geothermal fluid into the geothermally heated formation further comprises:
flowing, through the at least one extraction well, the geothermal fluid extracted from the geothermally heated formation to the surface of the earth;
pumping the geothermal fluid into the at least one injection well at the surface of the earth; and
flowing, through the at least one injection well, the geothermal fluid from the surface of the earth to the geothermally heated formation.

7. The process of claim 6, wherein pumping the geothermal fluid into the at least one injection well comprises filtering the geothermal fluid to remove substances that reduce permeability of the geothermally heated formation.

8. The process of claim 1, wherein the geothermally heated formation comprises a hydraulically stimulated formation.

9. The process of claim 1, wherein the geothermally heated formation comprises a temperature in a range of 150 and 450 degrees Celsius (300 and 850 degrees Fahrenheit).

10. The process of claim 1, wherein a wellhead of each well of the plurality of wells are located on a single well pad.

11. The process of claim 1, wherein obtaining the plurality of wells comprises drilling, using a drilling system, at least one of the plurality of wells.

12. A system for heat recovery from a geothermally heated formation, comprising:
a plurality of wells drilled from the surface of the earth into a geothermally heated formation, wherein the plurality of wells comprises at least one injection well and at least one closed-loop geothermal well;
a closed-loop geothermal system, inserted into each of the at least one closed-loop well, wherein each closed-loop geothermal system comprises:
a working fluid, configured to extract heat from a portion of rock and geothermal fluid in the geothermally heated formation,
a heat utilization facility located on the surface of the earth, wherein the heat utilization facility is configured to extract heat from the working fluid, and
a plurality of fluid conduits, wherein the working fluid flows downhole from the heat utilization facility through a first fluid conduit of the plurality of fluid conduits and the working fluid from downhole flows to the heat utilization facility through a second fluid conduit of the plurality of fluid conduits; and
a fluid injection system, configured to inject a flow of geothermal fluid into the geothermally heated formation through the at least one injection well, wherein the plurality of wells is configured to direct the flow of geothermal fluid from the at least one injection well to a vicinity of the at least one closed-loop geothermal well.

13. The system of claim 12, wherein the plurality of wells comprises at least one extraction well configured to extract geothermal fluid from the geothermally heated formation, and wherein the at least one injection well and the at least one extraction well are configured to cause a flow of geothermal fluid from the at least one injection well to the at least one extraction well through the vicinity of the at least one closed-loop geothermal well.

14. The system of claim 13, wherein:
a first distance between at least one closed-loop geothermal well and the at least one injection well is greater than a second distance between the at least one closed-loop geothermal well and the at least one extraction well; and
a third distance between the at least one extraction well and the at least one injection well is greater than the first distance.

15. The system of claim 12, wherein:
the injection of geothermal fluid through the at least one injection well and the extraction of geothermal fluid through the at least one extraction well is configured to preferentially direct the flow of geothermal fluid towards the at least one closed-loop geothermal well; and
the flow of geothermal fluid transports heat absorbed from the geothermally heated formation between the at least one injection well and the at least one closed-loop geothermal well.

16. The system of claim 12, further comprising:
a heat flow sensor disposed in the closed-loop geothermal system, configured to determine a measured flow of heat from the closed-loop geothermal system; and
a flow rate sensor, disposed in at least one of an injection well and an extraction well, configured to measure a flow rate of geothermal.

17. The system of claim 13, wherein injecting the geothermal fluid into the geothermally heated formation further comprises:
flowing, through the at least one extraction well, the geothermal fluid extracted from the geothermally heated formation to the surface of the earth;
pumping the geothermal fluid, without discharge to a surface environment, into the at least one injection well at the surface of the earth; and
flowing, through the at least one injection well, the geothermal fluid from the surface of the earth to the geothermally heated formation.

18. The system of claim 16, wherein pumping the geothermal fluid into the at least one injection well comprises filtering the geothermal fluid to remove substances that reduce permeability of the geothermally heated formation.

19. The system of claim 12, wherein the geothermally heated formation comprises a hydraulically stimulated formation.

20. The system of claim 12, wherein a wellhead of each well of the plurality of wells are located on a single well pad.

21. The system of claim 12, wherein the closed-loop geothermal system further comprises a downhole heat exchanger.

22. The system of claim 12, wherein the geothermally heated formation comprises a temperature in a range of 150 and 450 degrees Celsius (300 and 850 degrees Fahrenheit).
